(19) United States
(12) Patent Application Publication
(10) Pub. No.: US 2025/0319882 A1
(43) Pub. Date: Oct. 16, 2025

(54) SYSTEM AND METHOD FOR DETERMINING A DRIVER SCORE

(71) Applicant: GM GLOBAL TECHNOLOGY OPERATIONS LLC, Detroit, MI (US)

(72) Inventors: Alaa M. Khamis, Courtice, Ontario (CA); Abdulkabir Ajia, Leander, TX (US); Donald K. Grimm, Utica, MI (US); Jarvis Chau, Markham, Ontario (CA); Amin Abdossalami, Markham, Ontario (CA); Neeraj R. Gautama, Whitby, Ontario (CA)

(73) Assignee: GM GLOBAL TECHNOLOGY OPERATIONS LLC, Detroit, MI (US)

(21) Appl. No.: 18/636,531

(22) Filed: Apr. 16, 2024

(51) Int. Cl. B60W 40/09; B60W 50/14; G06N 3/02

(52) U.S. Cl. CPC B60W 40/09; B60W 50/14; G06N 3/02; B60W 2530/10; B60W 2540/22; B60W 2540/221; B60W 2556/10

(57) ABSTRACT

A method of determining a driver score for a driver of a vehicle. The method includes receiving at least one human influencing factor and embedding the at least one human influencing factor as a human vector, receiving at least one vehicle influencing factor and embedding the at least one vehicle influencing factor as a vehicle vector, and receiving at least one context influencing factor and embedding the at least one context influencing factor as a context vector. The method also concatenates the human vector, the vehicle vector, and the context vector to generate a concatenated vector and determines the driver score for the driver based on the concatenated vector utilizing a machine learning algorithm.

### INTRODUCTION

The present disclosure relates to a system and a method for determining a driver score.

Driver scores have become increasingly important in recent years to assess and promote improved driving behavior. Insurance companies, fleet managers, and individual drivers alike have recognized the value of quantifying and tracking driving performance to identify risky behaviors, encourage improvement, and potentially offer incentives for maintaining good scores.

### SUMMARY

Disclosed herein is a method of determining a driver score for a driver of a vehicle. The method includes receiving at least one human influencing factor and embedding the at least one human influencing factor into a human vector, receiving at least one vehicle influencing factor and embedding the at least one vehicle influencing factor into a vehicle vector, and receiving at least one context influencing factor and embedding the at least one context influencing factor into a context vector. The method also concatenates the human vector, the vehicle vector, and the context vector to generate a concatenated vector and determines the driver score for the driver based on the concatenated vector utilizing a machine learning algorithm.

In another aspect of the disclosure the at least one human influencing factor includes a driving characteristic of the driver.

In another aspect of the disclosure the driving characteristic includes at least one of a duration of vehicle operation for the driver or a health and emotional status of the driver.

In another aspect of the disclosure the at least one vehicle influencing factor includes a mechanical status of the vehicle.

In another aspect of the disclosure the at least one vehicle influencing factor includes at least one of a load type carried by the vehicle, a load status carried by the vehicle, or a service history of the vehicle.

In another aspect of the disclosure the at least one context influencing factor includes at least one of a temporal context, a spatial context, a spatiotemporal context, or a social context for the driver and the vehicle.

In another aspect of the disclosure determining an adaptive response by utilizing an adaptive response engine to evaluate the driver score and a major influencer to the driver score to determine the adaptive response.

In another aspect of the disclosure the major influencer is determined based on selecting which of the human vector, the vehicle vector, or the context vector provided a greatest contribution to the driver score.

In another aspect of the disclosure the adaptive response includes updating a route for the vehicle when the context vector provided the greatest contribution to the driver score and the driver score was below a predetermined threshold value.

In another aspect of the disclosure the adaptive response includes providing the driver a driver score explanation when the human vector provided the greatest contribution to the driver score and the driver score was below a predetermined threshold value.

In another aspect of the disclosure the adaptive response includes providing a vehicle maintenance alert when the vehicle vector provided the greatest contribution to the driver score and the driver score was below a predetermined threshold value.

In another aspect of the disclosure the adaptive response includes generating a driver score explanation for the driver when the driver score is below a predetermined threshold value.

In another aspect of the disclosure the driver score explanation is generated from a domain-specific large language model receiving at least the driver score and the major influencer.

Also disclosed herein is a non-transitory computer-readable storage medium embodying programmed instructions which, when executed by a processor, are operable for performing a method. The method includes receiving at least one human influencing factor and embedding the at least one human influencing factor into a human vector, receiving at least one vehicle influencing factor and embedding the at least one vehicle influencing factor into a vehicle vector, and receiving at least one context influencing factor and embedding the at least one context influencing factor into a context vector. The method also concatenates the human vector, the vehicle vector, and the context vector to generate a concatenated vector and determines the driver score for the driver based on the concatenated vector utilizing a machine learning algorithm.

In another aspect of the disclosure the method includes determining an adaptive response by utilizing an adaptive response engine to evaluate the driver score and a major influencer to the driver score to determine an adaptive response.

In another aspect of the disclosure the major influencer is determined based on selecting which of the human vector, the vehicle vector, or the context vector provided a greatest contribution to the driver score.

In another aspect of the disclosure the adaptive response includes providing the driver with a driver score explanation when the human vector provided the greatest contribution to the driver score and the driver score was below a predetermined threshold value.

In another aspect of the disclosure the driver score explanation for the driver is generated from a large language model receiving at least the driver score and the major influencer.

Also disclosed herein is a vehicle. The vehicle includes a body defining a passenger compartment, wheels supporting the body, sensors fixed relative to the body and a controller in communication with the sensors. The controller is programmed to receive at least one human influencing factor and embedding the at least one human influencing factor into a human vector, receive at least one vehicle influencing factor and embedding the at least one vehicle influencing factor into a vehicle vector, and receive at least one context influencing factor and embedding the at least one context influencing factor into a context vector. The controller is also programmed to concatenate the human vector, the vehicle vector, and the context vector to generate a concatenated vector and determine a driver score for a driver based on the concatenated vector utilizing a machine learning algorithm.

In another aspect of the disclosure the controller is programmed to determine an adaptive response by utilizing an adaptive response engine to evaluate the driver score and a major influencer on the driver score.

### BRIEF DESCRIPTION OF THE DRAWINGS

FIG. 1 is a schematic illustration of an example vehicle.

FIG. 2 schematically illustrates an example flowchart of determining a driver score.

FIG. 3 schematically illustrates an example flowchart for operating an adaptive response engine.

FIG. 4 schematically illustrates an example flowchart for providing an explanation to a driver as an adaptive response of the adaptive response engine of FIG. 3.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

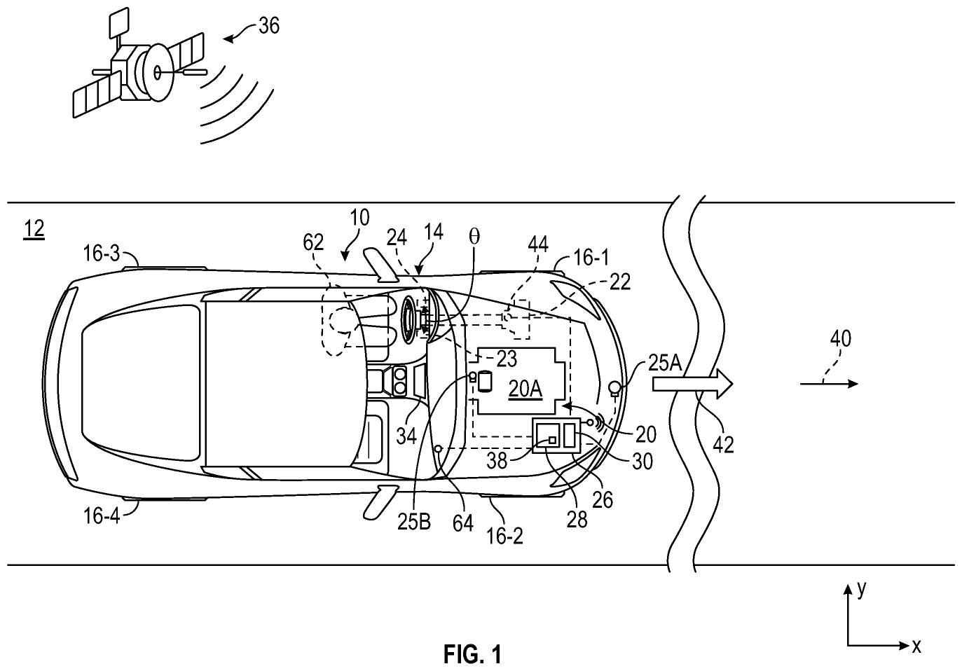

Referring to the FIGS., wherein like numerals indicate like parts referring to the drawings, wherein like reference numbers refer to like components, FIG. 1 shows a schematic view of a motor vehicle 10 positioned relative to a road surface, such as a vehicle lane 12. As shown in FIG. 1, the vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide fictional contact with the vehicle lane 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the vehicle lane 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators 22 (for example, an electrical power steering unit) configured to steer the road wheels 16-1, 16-2, a steering angle (θ), an accelerator device 23 for controlling power output of the power-source(s) 20A, a braking switch or device 24 for retarding rotation of the road wheels 16-1 and 16-2 (such as via individual friction brakes located at respective road wheels), etc.

As shown in FIG. 1, the motor vehicle 10 includes at least one sensor 25A and an electronic controller 26 that cooperate to at least partially control, guide, and maneuver the vehicle 10 in an autonomous mode during certain situations. As such, the vehicle 10 may be referred to as an automated driving vehicle. To enable efficient and reliable control of the automated driving vehicle, the electronic controller 26 may be in operative communication with the steering actuator(s) 22 configured as an electrical power steering unit, accelerator device 23, and braking device 24. The sensors 25A of the motor vehicle 10 are operable to sense the vehicle lane 12 and monitor a surrounding geographical area and traffic conditions proximate the motor vehicle 10.

The sensors 25A of the vehicle 10 may include, but are not limited to, at least one of a Light Detection and Ranging (LIDAR) sensor, radar, or camera (optical sensor) located around the vehicle 10 to detect the boundary indicators, such as edge conditions, of the vehicle lane 12. The type of sensors 25A, their location on the vehicle 10, and their operation for detecting and/or sensing the boundary indicators of the vehicle lane 12 and monitor the surrounding geographical area and traffic conditions are understood by those skilled in the art, are not pertinent to the teachings of this disclosure, and are therefore not described in detail herein. The vehicle 10 may additionally include sensors 25B attached to the vehicle body and/or drivetrain 20.

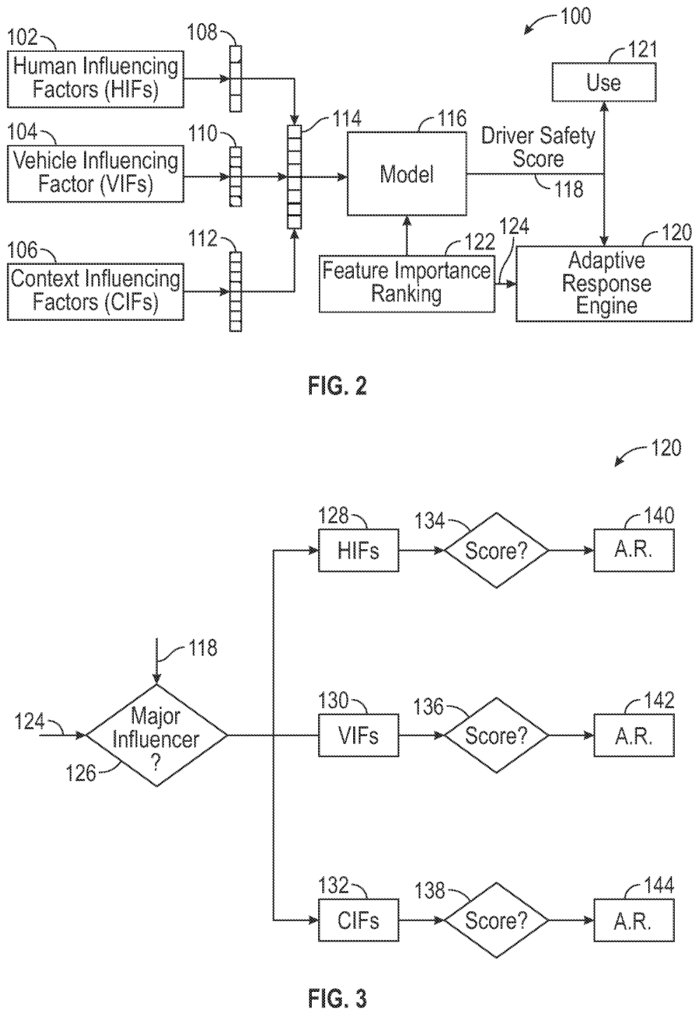

The electronic controller 26 is disposed in communication with the sensors 25A of the vehicle 10 for receiving their respective sensed data related to the detection or sensing of the vehicle lane 12 and monitoring of the surrounding geographical area and traffic conditions. The electronic controller 26 may alternatively be referred to as a control module, a control unit, a controller, a vehicle 10 controller, a computer, etc. The electronic controller 26 may include a computer and/or processor 28, and include software, hardware, memory, algorithms, connections (such as to sensors 25A and 25B), etc., for managing and controlling the operation of the vehicle in 10. As such, a method, described below and generally represented in FIG. 2, may be embodied as a program or algorithm partially operable on the electronic controller 26. It should be appreciated that the electronic controller 26 may include a device capable of analyzing data from the sensors 25A and 25B, comparing data, making the decisions required to control the operation of the vehicle 10, and executing the required tasks to control the operation of the vehicle 10.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 26 includes a tangible, non-transitory memory 30 on which computer-executable instructions, including one or more algorithms, are recorded for regulating operation of the motor vehicle 10. The subject algorithm(s) may specifically include an algorithm configured to determine a driver score for the driver 62 and provide an adaptive response as discussed below with reference to the methods 100 and 200.

The motor vehicle 10 also includes a vehicle navigation system 34 having a human interface, which may be part of integrated vehicle controls, or an add-on apparatus used to find travel direction in the vehicle. The vehicle navigation system 34 is also operatively connected to a global positioning system (GPS) 36 using an earth orbiting satellite. The vehicle navigation system 34 in connection with the GPS 36 and the above-mentioned sensors 25A may be used for automation of the vehicle 10. The electronic controller 26 is in communication with the GPS 36 via the vehicle navigation system 34. The vehicle navigation system 34 uses a satellite navigation device (not shown) to receive its position data from the GPS 36, which is then correlated to the vehicle's position relative to the surrounding geographical area. Based on such information, when directions to a specific waypoint are needed, routing to such a destination may be mapped and calculated. On-the-fly terrain and/or traffic information may be used to adjust the route. The current position of a vehicle 10 may be calculated via dead reckoning—by using a previously determined position and advancing that position based upon given or estimated speeds over elapsed time and course by way of discrete control points.

The electronic controller 26 is generally configured, i.e., programmed, to determine or identify localization 38 (current position in the X-Y plane, shown in FIG. 1), velocity, acceleration, yaw rate, as well as intended path 40, and heading 42 of the motor vehicle 10 on the vehicle lane 12. The localization 38, intended path 40, and heading 42 of the motor vehicle 10 may be determined via the navigation system 34 receiving data from the GPS 36, while velocity, acceleration (including longitudinal and lateral g's), and yaw rate may be determined from vehicle sensors 25B. Alternatively, the electronic controller 26 may use other systems or detection sources arranged remotely with respect to the vehicle 10, for example a camera, to determine localization 38 of the vehicle relative to the vehicle lane 12.

As noted above, the motor vehicle 10 may be configured to operate in an autonomous mode guided by the electronic controller 26 to transport an occupant or driver 62. In such a mode, the electronic controller 26 may further obtain data from vehicle sensors 25B to guide the vehicle along the desired path, such as via regulating the steering actuator 22. The electronic controller 26 may be additionally programmed to detect and monitor the steering angle (θ) of the steering actuator(s) 22 along the desired path 40, such as during a negotiated turn. Specifically, the electronic controller 26 may be programmed to determine the steering angle (θ) via receiving and processing data signals from a steering position sensor 44 (shown in FIG. 1) in communication with the steering actuator(s) 22, accelerator device 23, and braking device 24.

FIG. 2 illustrates a method 100 of determining a driver score for a driver of the vehicle 10. In the illustrated example, the driver score is determined based on several different factors, such as human influencing factors (HIFs), vehicle influencing factors (VIFs), and context influencing factors (CIFs). One feature of this disclosure is to determine a driver score that is based on a combination of these factors. For example, this disclosure considers factors beyond the driver behaviors and driving history to determine a driver score, such as by utilizing vehicle related information in the VIFs and contextual related information in the CIFs to determine the driver score as described in greater detail below.

As shown at Block 102, the method 100 obtains one or more HIFs. In one example, the HIFs include characteristics related to the driver of the vehicle 10. The characteristic can include indicators of aggressive driving, such as a number of driver collision warnings provided by the vehicle 10 within a predetermined time or distance. The indicators of aggressive driving can include braking above a predetermined deceleration threshold, accelerating above a predetermined acceleration threshold, corning above a predetermined lateral acceleration, a vehicle headway below a predetermined minimum headway threshold, or a velocity above a legal limit for a given road segment. The HIFs can also include use of vehicle features, such as seat belts, active features, a duration of time the driver has operated the vehicle 10, a medical history of the driver, or live health monitoring data obtained from a wearable device on the driver. The wearable device can be capable of tracking at least one of hours of sleep, heart rate, activity level, breathing, perspiration level, HRV, ECG, or blood pressure of the driver. The HIFs can also include a state, such as distracted, drowsy, fatigued, etc., of the driver determined by at least one camera 64 located within the passenger compartment of the vehicle 10 monitoring the driver.

At Block 104, the method 100 obtains one or more VIFs. In one example, the VIFs include a health status of the vehicle 10, such as brake pad life, oil status, tire wear, etc. In another example, the VIFs include historical vehicle damage information, including a description of damage to the vehicle 10, repairs performed on the vehicle 10, and a date associated with the damage that occurred and the repairs that were performed. Furthermore, if the vehicle 10 is carrying a load, the VIFs can include information regarding the load, such as type, mass, or trailer configuration. The VIFs can also include information regarding load status, such as if it is improperly secured, has shifted, or was improperly wrapped. Such information can be determined as disclosed in U.S. patent application Ser. No. 17/973,763 entitled “MULTIMODAL FREIGHT MONITORING AND CONTEXTUAL NOTIFICATION FOR DELIVERY VEHICLE” filed Nov. 11, 2022, with the disclosure hereby incorporated by reference in its entirety.

At Block 106, the method obtains one or more CIFs. The CIFs describe contextual attributes or information relative to the driver and the vehicle 10 under current driving conditions and historical patterns. In one example, the CIFs include a spatial context. The spatial context can provide an operation location of the vehicle 10 and if the driver has traveled along a corresponding roadway at least a predetermined number of times previously. In another example, the spatial context can include a road segment roughness/road disruption score describing a surface of the road segment including potholes or disruptions in the road surface. In yet another example, the spatial context can include a driving risk score or a location score describing an aggregate number of collisions, near-miss events, anomalous driving behaviors or road rule violations that have occurred on the corresponding roadway.

In another example, the CIFs describe a temporal context. The temporal context can include at least one of a time of day or day of the week that the driver is operating the vehicle 10. The temporal context can also include historical patterns of for the driver operating the vehicle 10.

In yet another example, the CIFs can also include spatiotemporal context, such as roadway dynamics and an environmental context as they change with time and space. In one example, the roadway dynamics include vehicle speed, pedal usage for the brake and accelerator by the driver, full or idle stopping periods, or a difference in speed between lanes of traffic on the vehicle lane 12. In one example, the environmental context can include at least one of sun glare relative to a direction of travel of the vehicle 10, road traction, traffic, weather, or lighting conditions.

Furthermore, the CIFs can also include a battery economic context and a social context. The battery economic context can include a level of charge if the vehicle 10 is an electric vehicle. The level of charge of the battery can correspond to a driver's anxiety to charge the vehicle 10 prior to reaching a desired location. The social context can include at least one of a number and location of occupants within the vehicle 10, if the occupants are being disruptive, if the occupants include children or pets, or behaviors of other drivers surrounding the vehicle 10, such as a distance to other vehicles and number of lane changes being performed by the other vehicles.

For the HIFs, VIFs, and CIFs to be related to each other for the purpose of generating a driver score in this disclosure, the method 100 performs an embedding process for the HIFs, VIFs, and CIFs Blocks 108, 110, and 112, respectively, to generate a HIF vector, a VIF vector, and a CIF vector. In one example, the embedding process occurs with a neural network utilizing a transform encoder that transforms the individual influencing factors into a vector for purposes of evaluation.

Furthermore, a graph embedding process can utilize a graph neural network (GNN), a graph convolution network (GCN), or a graph attention network (GAT) if one of the HIFs, VIFs, or CIFs are represented in a graphical format. In the illustrated example, the CIFs can be represented in a graph-structured data format with node features representing a corresponding one of the contexts, such as spatial context, temporal context, environmental context, economic context, social context, etc. The relationships between the nodes in this graph-structured data are represented by an adjacency matrix. Once the embedding has occurred for each set of HIFs, VIFs, and CIFs as described above, the method 100 proceeds to Block 114.

At Block 114, the method 100 performs a concatenated embedding process to combine the HIF vector, the VIF vector, and the CIF vector into a concatenation vector. The concatenated embedding process can apply different weights to each of the vectors, such as by applying a greater weight to the HIF vector than the VIF vector or the CIF vector. The concatenation vector from Block 114 can then be utilized at Block 116 to determine and output the driver score 118.

A Block 116, the method 100 utilizes a classification/regression model for determining the driver score 118 based on the concatenated vector. In one example, the classification/regression model utilizes a machine learning algorithm to determine the driver score 118. The driver score can be categorical, such as in predetermined tiers including a very low score, a low score, a medium score, or a high score. Alternatively, the driver score 118 can be continuous and have a predetermined range of score values corresponding to a very low range, a low range, a medium range, or a high range. One feature of having the driver score 118 being continuous is that it provides a more fine-grained description of the driver's behavior beyond a limited number of categories as described above.

With the driver score 118 output from Block 116, the method 100 provides the driver score 118 to an adaptive response engine at Block 120 or a use case at Block 121. Example use cases at Block 120 can include determining auto insurance for the driver, determining a location profile based on driver scores of drivers in a predetermined area, maintaining a recording a HIFs, VIFs, and CIFs to reconstruct a driver's behavior or profile during a given time period, or storing the driver score 118 in a cloud-based service that allows the driver score 118 to be shared among different vehicles operated by the driver.

The adaptive response engine at Block 120 provides an adaptive response that includes at least one of a recommendation or explanation based on the driver score 118 and a major influencing factor to the driver score 118 as discussed below. By providing the recommendation or explanation, the adaptive response engine at Block 120 can assist the driver or a vehicle manager in improving the driver score 118. A method 200 of providing the explanation to the driver will be described in greater detail below.

For the adaptive response engine at Block 120 to provide at least one of a recommendation or an explanation, a feature importance ranking is performed at Block 122. The feature importance ranking at Block 122 communicates with the classification/regression model at Block 116 to determine which of the influencing factors from Blocks 102, 104, or 106 were the major influencer in generating the driver score 118. In one example, the feature importance ranking at Block 122 utilizes statistical machine learning and analysis to determine which of the influencing factors were the major influencer on the driver score 118. Alternatively, the major influencer can be determined based on evaluating how the machine learning algorithm from Block 116 generated the driver score 118.

With the major influencer 124 determined at Block 122 and the driver score 118, the adaptive response engine at Block 120 and further illustrated in FIG. 3 proceeds to a corresponding one of the major influencer Blocks, such as the HIF at Block 128 if the HIF was the major influencer at Block 126, the VIF at Block 130 if the VIF was the major influencer at Block 126, or the CIF at Block 132 if the CIF was the major influence at Block 126. With the major influencer determined, the adaptive response engine at Block 120 determines a corresponding score at one of Blocks 134, 136, and 138 for the corresponding major influencer determined. In one example, the score from one of Blocks 134, 136 and 138 can be categorical, such as a very low score, a low, a medium score, or a high score. With the score from Blocks 134, 136 and 138 categorized, the adaptive response engine at Block 120 can then provide an adaptive response at Blocks 140, 142, and 144, respectively.

If the major influencer 124 was determined to be the HIF at Block 126, and the HIF score at Block 134 was determined to be very low or low, the adaptive response engine at Block 120 can provide an adaptive response at Block 140. The adaptive response at Block 140 can include at least one of an explanation for the driver score or a recommendation based on the driver score 118 and major influencer 124. The explanation or the recommendation can be provided through the vehicle navigation 34 having a human interface on the vehicle 10 or through an auditory broadcast through the vehicle 10.

Additionally, the adaptive response at Block 140 can include an adjustment to an advanced driver assistance system (ADAS), such as increasing vehicle spacing or reducing vehicle speed. Furthermore, the adaptive response from Block 140 can be used to track the driver's history, such as through updating a fleet driver card, or the adaptive response from Block 140 can be used for purposes of determining auto-insurance for the driver. Additionally, if the score at Block 134 was determined to be medium or high, the adaptive response at Block 140 can update the driver's record, such as through update the fleet driver card, or it could be used for purposes of determining auto-insurance for the driver.

If the major influencer 124 was determined to be the VIF at Block 126, and the VIF score at Block 136 was determined to be very low or low at Block 136, the adaptive response engine at Block 120 can provide an adaptive response at Block 142. In one example, the adaptive response at Block 140 could include an alert to the driver or a fleet manager regarding an issue with the vehicle 10 or adjust ADAS features, such as increasing vehicle spacing or reducing vehicle speed, to improve the score of the vehicle 10.

Alternatively, if the VIF score at Block 136 was determined to be medium or high, the adaptive response at Block 142 could include an alert to review vehicle maintenance prior to trip with the vehicle 10. This adaptive response could include an alert to check vehicle maintenance items, such as tire pressure, windshield washer fluid, etc.

If the major influencer 124 was determined to be the CIF at Block 126, and the CIF score at Block 138 was determined to be very low or low at Block 138, the adaptive response engine at Block 120 can provide an adaptive response at Block 144. In one example, the adaptive response at Block 144 can include a change to a vehicle route or provide an alert to the driver. The alert provided can be due to a number of different contextual factors, such as poor road condition causing an uneven road surface or environmental conditions impacting the road surface. If the CIF score at Block 138 was determined to be medium or high, the adaptive response engine at Block 120 can alert the driver to favorable conditions or take no further action.

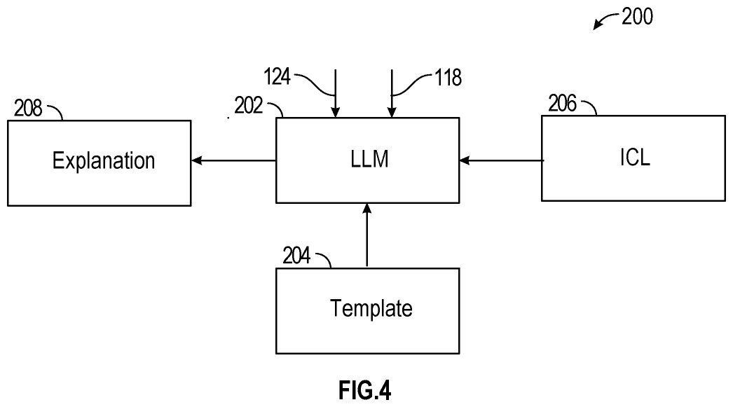

FIG. 4 illustrates an example flowchart of a method 200 of generating an explanation to the driver of the vehicle 10 as one of the adaptive responses from one of Blocks 140, 142, or 144. As described above, the adaptive responses at Blocks 140, 142, or 144 can perform an action that includes at least one of changing an operating parameter of the vehicle, providing a recommendation, or providing an explanation to the driver based on the driver score 118.

The method 200 begins at Block 202 by obtaining the major influencer 124 and the driver score 118. The major influencer 124 and the driver score 118 are then utilized by a large language model (LLM) at Block 202 for generating the explanation at Block 208. As part of generating the explanation at Block 208, the LLM can receive a template from Block 204.

In the illustrated example, the template from Block 204 includes an issue, such as the driver score 118, the major influencer 124 leading to the driver score, and an explanation, such as the underlying factors that led to the driver score 118 and recommendations for the driver. One feature of providing the explanation is to improve the driver score 118 of the driver as will be discussed in greater detail below.

The general-purpose large language model at Block 202 can be converted into a domain-specific LLM using techniques like Retrieval Augmented Generation (RAG) or In-context learning (ICL). In context learning (ICL) from Block 206 improves the LLMs ability to generate the explanation at Block 208 by supplementing the training of the LLM. In particular, the LLM may be pre-trained on a vast amount of data enabling it to develop a broad understanding of language and various tasks. However, the pre-training of the LLM may not include training examples of providing an explanation to driver based on a driver score and underlaying factors that led to that driver score.

To provide additional training to the LLM at Block 202, the ICL can include a few-shot ICL, a one-shot ICL, a zero-shot ICL, or a fine-tuning ICL. For the example of a few-shot ICL, the LLM with frozen parameters at Block 202 can include specific training for providing more accurate and relevant domain-specific explanation to the driver at Block 208. The specific training can be based on a small number of training examples, such as between 3 and 10 examples. Each of the training examples can include information as outlined in the template from Block 204 including the driver score, the major influencing factor, and the underlying factors that led to a given response.

Alternatively, the method 200 could utilize the one-shot ICL that provides a single training example, the zero-shot ICL that provides a natural language description, or the fine-tuned ICL. For the example of providing the fine-tuned LLM, the additional training data can include a large number of training examples following the template from Block 204, such as more than 1,000 examples and less than 10,000 examples.

With the information obtained from Blocks 104 and 206, the LLM at Block 202 can provide an explanation based on the driver score 118 and the major influencer 124. In one example, the explanation provided at Block 204 will follow the template from Block 204 and provide the underlying factor(s) and recommendation for improving the driver score. For example, if the driver score 118 was determined to be low with the major influencer 124 being the HIFs, the method 200 can provide an explanation at Block 208 to the driver to guide or coach the driver to improve the driver score 118. One feature of providing the explanation is that the driver will be informed of the underlying factors that led to the low driver score and will therefore be able to improve the driver score by following the recommendations.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element, or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A method of determining a driver score for a driver of a vehicle, the method comprising:
receiving at least one human influencing factor and embedding the at least one human influencing factor into a human vector;
receiving at least one vehicle influencing factor and embedding the at least one vehicle influencing factor into a vehicle vector;
receiving at least one context influencing factor and embedding the at least one context influencing factor into a context vector;
concatenating the human vector, the vehicle vector, and the context vector to generate a concatenated vector; and
determining the driver score for the driver based on the concatenated vector utilizing a machine learning algorithm.

2. The method of claim 1, wherein the at least one human influencing factor includes a driving characteristic of the driver.

3. The method of claim 2, wherein the driving characteristic includes at least one of a duration of vehicle operation for the driver or a health and emotional status of the driver.

4. The method of claim 1, wherein the at least one vehicle influencing factor includes a mechanical status of the vehicle.

5. The method of claim 1, wherein the at least one vehicle influencing factor includes at least one of a load type carried by the vehicle, a load status carried by the vehicle, or a service history of the vehicle.

6. The method of claim 1, wherein the at least one context influencing factor includes at least one of a temporal context, a spatial context, a spatiotemporal context, or a social context for the driver and the vehicle.

7. The method of claim 1, including determining an adaptive response by utilizing an adaptive response engine to evaluate the driver score and a major influencer to the driver score to determine the adaptive response.

8. The method of claim 7, wherein the major influencer is determined based on selecting which of the human vector, the vehicle vector, or the context vector provided a greatest contribution to the driver score.

9. The method of claim 8, wherein the adaptive response includes updating a route for the vehicle when the context vector provided the greatest contribution to the driver score and the driver score was below a predetermined threshold value.

10. The method of claim 8, wherein the adaptive response includes providing the driver a driver score explanation when the human vector provided the greatest contribution to the driver score and the driver score was below a predetermined threshold value.

11. The method of claim 8, wherein the adaptive response includes providing a vehicle maintenance alert when the vehicle vector provided the greatest contribution to the driver score and the driver score was below a predetermined threshold value.

12. The method of claim 8, wherein the adaptive response includes generating a driver score explanation for the driver when the driver score is below a predetermined threshold value.

13. The method of claim 12, wherein the driver score explanation is generated from a domain-specific large language model receiving at least the driver score and the major influencer.

14. A non-transitory computer-readable storage medium embodying programmed instructions which, when executed by a processor, are operable for performing a method comprising:
receiving at least one human influencing factor and embedding the at least one human influencing factor into a human vector;
receiving at least one vehicle influencing factor and embedding the at least one vehicle influencing factor into a vehicle vector;
receiving at least one context influencing factor and embedding the at least one context influencing factor into a context vector;
concatenating the human vector, the vehicle vector, and the context vector to generate a concatenated vector; and
determining a driver score for a driver based on the concatenated vector utilizing a neural network.

15. The non-transitory computer-readable storage medium of claim 14, wherein the method includes determining an adaptive response by utilizing an adaptive response engine to evaluate the driver score and a major influencer to the driver score to determine an adaptive response.

16. The non-transitory computer-readable storage medium of claim 15, wherein the major influencer is determined based on selecting which of the human vector, the vehicle vector, or the context vector provided a greatest contribution to the driver score.

17. The non-transitory computer-readable storage medium of claim 16, wherein the adaptive response includes providing the driver with a driver score explanation when the human vector provided the greatest contribution to the driver score and the driver score was below a predetermined threshold value.

18. The non-transitory computer-readable storage medium of claim 17, wherein the driver score explanation for the driver is generated from a large language model receiving at least the driver score and the major influencer.

19. A vehicle comprising:
a body defining a passenger compartment;
a plurality of wheels supporting the body;
a plurality of sensors fixed relative to the body; and
a controller in communication with the plurality of sensors, the controller being programmed to:
receive at least one human influencing factor and embedding the at least one human influencing factor into a human vector;
receive at least one vehicle influencing factor and embedding the at least one vehicle influencing factor into a vehicle vector;
receive at least one context influencing factor and embedding the at least one context influencing factor into a context vector;
concatenate the human vector, the vehicle vector, and the context vector to generate a concatenated vector; and
determine a driver score for a driver based on the concatenated vector utilizing a machine learning algorithm.

20. The vehicle of claim 19, wherein the controller is programmed to determine an adaptive response by utilizing an adaptive response engine to evaluate the driver score and a major influencer on the driver score.
